(19) United States
(12) Patent Application Publication
(10) Pub. No.: US 2021/0349444 A1
(43) Pub. Date: Nov. 11, 2021

(54) ACCELERATING ROBOTIC PLANNING FOR OPERATING ON DEFORMABLE OBJECTS

(71) Applicant: X Development LLC, Mountain View, CA (US)

(72) Inventor: Michael Hemmer, San Francisco, CA (US)

(21) Appl. No.: 16/872,283

(22) Filed: May 11, 2020

(51) Int. Cl. G05B 19/4155; G06N 3/08; B25J 9/16

(52) U.S. Cl. CPC G05B 19/4155; G06N 3/08; G05B 2219/50391; G05B 2219/41054; B25J 9/1664

(57) ABSTRACT

Methods, systems, and apparatus, including computer programs encoded on computer storage media, for training a neural network including an encoder network and decoder network and configured to receive a network input that includes sensor data characterizing a deformable object and to process the network input to generate a network output that specifies a mesh of the deformable object. Once trained, the neural network can be deployed in a robotic system for use in allowing a motion planner to issue timely commands which adjust a currently planned motion according to the mesh in order to prevent any collision between the robot and the deformable object.

### BACKGROUND

This specification relates to robotics, and more particularly to planning robotic movements.

Robotics planning refers to scheduling the physical movements of robots in order to perform tasks. For example, an industrial robot that builds cars can be programmed to first pick up a car part and then weld the car part onto the frame of the car. Each of these actions can themselves include dozens or hundreds of individual movements by robot motors and actuators.

Robotics planning has traditionally required immense amounts of manual programming in order to meticulously dictate how the robotic components should move in order to accomplish a particular task. Manual programming is tedious, time-consuming, and error prone. In addition, a schedule that is manually generated for one workcell can generally not be used for other workcells. In this specification, a workcell is the physical environment in which a robot will operate. Workcells have particular physical properties, e.g., physical dimensions, that impose constraints on how robots can move within the workcell. Thus, a manually programmed schedule for one workcell may be incompatible with a workcell having different robots, a different number of robots, or different physical dimensions.

In various scenarios, the tasks involve operating on deformable objects, i.e., objects that are not fully rigid (at least during operation). In these scenarios, robotics planning further requires adjusting currently planned robot motions in a timely manner to account for any deformation of the objects (that happens after the current robot motion has been planned) and to avoid potential collisions between the robots and the objects. Conventional approaches to this issue rely on iterative or geometric fitting processes to generate estimated mesh representations of the deformable objects. Robot motions can then be adjusted based on the estimated mesh representations. Such processes, however, can be time-consuming and thus are not suitable for online operations, especially when the robots are moving at high speeds.

### SUMMARY

This specification describes how a system implemented as computer programs for use in predicting estimated mesh representations of objects. For example, the objects can be target objects which a robot is operating on. In particular, the objects may include deformable objects, i.e., objects that are not fully rigid (at least during robot operation). A mesh representation is typically a multi-dimensional computer graphics modeling of a physical object.

Particular embodiments of the subject matter described in this specification can be implemented so as to realize one or more of the following advantages. In various robotics tasks, a robot may be required to operate on deformable objects.

In order for a motion planner to issue commands which cause a robot to move along a safe and collision-free trajectory, the motion planner must be provided with timely and accurate mesh data which specifying respective predicted mesh representations of deformable objects. Conventional approaches for generating predicted mesh representations for objects involves iterative or geometric-based fitting processes, which may be time-consuming and may require substantial computational resources (e.g., memory, computing power, or both). In certain situations, the robot may operate on a large number of deformable objects or move at high speeds. In these situations and other similar situations, such conventional approaches may be insufficient to generate timely predicted mesh representations.

The encoder-decoder engine described in this specification, however, can be configured to predict mesh representations over time lengths that are much shorter than those required by the conventional, iterative processes. Specifically, the encoder-decoder engine receives sensor data characterizing an object and processes the sensor data to generate an output which specifies a predicted mesh representation of the object.

In addition, this specification discloses techniques for effectively training such encoder-decoder engines by making use of a mesh reduction network that is configured to process input sensor data and to generate an output which specifies a compressed latent representation of the input sensor data. The described techniques can be used to train the encoder-decoder engine to predict, i.e., at run-time, high-quality mesh representations of different objects, even when the input sensor data is noisy or incomplete, i.e., does not characterize a complete shape of the object.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram that illustrates an example robotics system.

FIG. 2A is a block diagram of an example training system in context of training a mesh reduction network and a decoder network.

FIG. 2B is a block diagram of the example training system in context of training an encoder network.

FIG. 3 is a flowchart of an example process for training the networks to generate reconstructed meshes or latent representations.

FIG. 4 is a flowchart of an example process for training the networks to generate predicted meshes.

Like reference numbers and designations in the various drawings indicate like elements.

### DETAILED DESCRIPTION

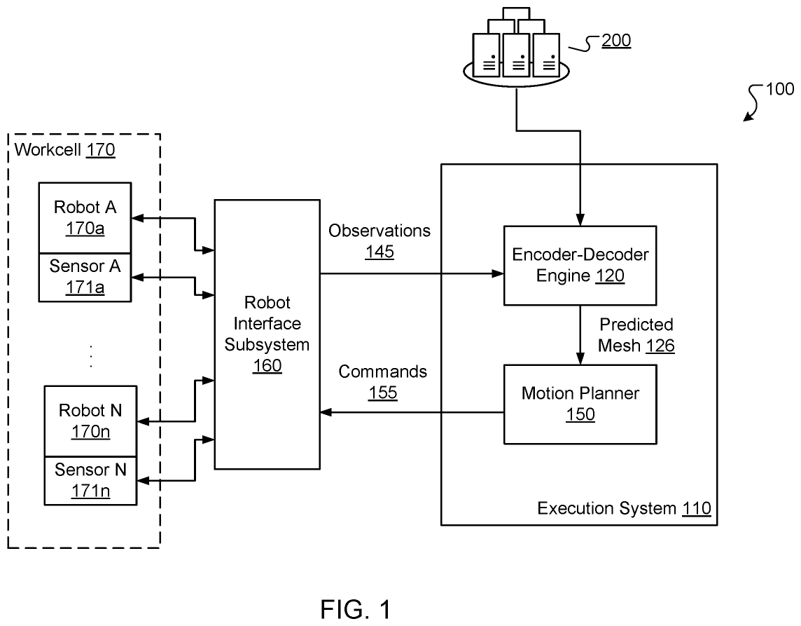

FIG. 1 is a diagram that illustrates an example robotics system 100. The robotics system 100 is an example of a system that can implement the online robotic control techniques described in this specification.

The robotics system 100 includes a number of functional components, including an online execution system 110 and a robot interface subsystem 160. Each of these components can be implemented as computer programs installed on one or more computers in one or more locations that are coupled to each other through any appropriate communications network, e.g., an intranet or the Internet, or combination of networks.

In general, the online execution system 110 provides commands 155 to be executed by the robot interface subsystem 160, which drives one or more robots, e.g., robots 170a-n, in a workcell 170. In order to compute the commands 155, the online execution system 110 receives online observations 145 made by one or more sensors 171a-n making observations within the workcell 170. As illustrated in FIG. 1, each sensor 171 is coupled to a respective robot 170. However, the sensors need not have a one-to-one correspondence with robots and need not be coupled to the robots. In fact, each robot can have multiple sensors, and the sensors can be mounted on stationary or movable surfaces in the workcell 170.

The robot interface subsystem 160 and the online execution system 110 can operate according to different timing constraints. In some implementations, the robot interface subsystem 160 is a real-time software control system with hard real-time requirements. Real-time software control systems are software systems that are required to execute within strict timing requirements to achieve normal operation. The timing requirements often specify that certain actions must be executed or outputs must be generated within a particular time window in order for the system to avoid entering a fault state. In the fault state, the system can halt execution or take some other action that interrupts normal operation.

The online execution system 110, on the other hand, typically has more flexibility in operation. In other words, the online execution system 110 may, but need not, provide a command 155 within every real-time time window under which the robot interface subsystem 160 operates. However, in order to provide the ability to make sensor-based reactions, the online execution system 110 may still operate under strict timing requirements. In a typical system, the real-time requirements of the robot interface subsystem 160 require that the robots provide a command every 5 milliseconds, while the online requirements of the online execution system 110 specify that the online execution system 110 should provide a command 155 to the robot interface subsystem 160 every 20 milliseconds. However, even if such a command is not received within the online time window, the robot interface subsystem 160 need not necessarily enter a fault state.

Thus, in this specification, the term online refers to both the time and rigidity parameters for operation. The time windows are larger than those for the real-time robot interface subsystem 160, and there is typically more flexibility when the timing constraints are not met.

In operation, the online execution system 110 repeatedly (i.e., at each of multiple time points) obtains observations 145 and issues commands 155 to the robot interface system 160 in order to actually drive the movements of the moveable components, e.g., the joints, of the robots 170a-n.

In some implementations, the robot interface subsystem 160 provides a hardware-agnostic interface so that the commands 155 issued by onsite execution engine 150 are compatible with multiple different versions of robots. During execution the robot interface subsystem 160 can report online observations 145 back to the online execution system 110 so that the online execution system 150 can make online adjustments to the robot movements, e.g., due to deformation of target object or other unanticipated conditions.

Specifically, the execution system 110 issues the commands 155 by using a motion planner 150. The motion planner 150 is configured to process observations 145, data derived from observations 145, or both and to generate commands 155 which plan respective future trajectories of the robots 170a-n.

In execution, the robots 170a-n generally continually execute the commands specified explicitly or implicitly by the motion plans to perform the various tasks or transitions of the schedule. The robots can be real-time robots, which means that the robots are programmed to continually execute their commands according to a highly constrained timeline. For example, each robot can expect a command from the robot interface subsystem 160 at a particular frequency, e.g., 100 Hz or 1 kHz. If the robot does not receive a command that is expected, the robot can enter a fault mode and stop operating.

In general, the execution system 110 can control the robots 170a-n to perform any of a variety of tasks, including, for example, assembly, handling, packing, or gluing tasks. In particular, certain tasks involve operating on deformable objects, i.e., objects that are not fully rigid (at least during operation). In these scenarios, the tasks further require adjusting currently planned robot motions in a timely manner to account for any deformation of the objects (that happens after the current robot motion has been planned) and to avoid potential collisions between the robots and the objects.

Conventional approaches to this issue rely on iterative or geometric-based fitting processes to generate estimated mesh representations of the deformable objects. Typically, each mesh representation is a multi-dimensional computer graphics modeling of a physical object. For example, the mesh representation includes information that specify the shape, volume, or texture of the physical object. The motion planner 150 can then adjust the currently planned motions of the robots based on the estimated mesh representations. Such iterative or geometric-based processes, however, can be time-consuming and thus are not suitable for online operations, especially when the robots are moving at high speeds.

To accelerate the mesh estimation process, the execution system 110 implements an encoder-decoder engine 120 that is configured to receive observations 145 and to generate predicted meshes 126 of the deformable objects. In particular, the engine 120 is capable of performing each estimation process over a time length that is much shorter than those required by iterative processes. For example, the engine 120 can generate an estimated mesh for each deformable object that is characterized by the observation within 10 or 100 milliseconds, whereas each iterative process is typically between 1 and 5 seconds in time length. In this way, the execution system 110 can obtain up-to-date meshes orders of magnitudes faster than using existing approaches. The execution system 100 then uses the motion planner 150 to generate, from a currently planned motion, an adjusted motion according to the mesh representing the deformable object and thereafter issues new commands 155 to cause the robots to execute the adjusted motion.

Typically, the encoder-decoder engine 120 is configured as a neural network having a plurality of network parameters. To allow the encoder-decoder engine 120 to generate accurate predicted meshes, a training system 200 can determine trained parameter values of the engine 120. Training the encoder-decoder engine 120 will be described in more detail below.

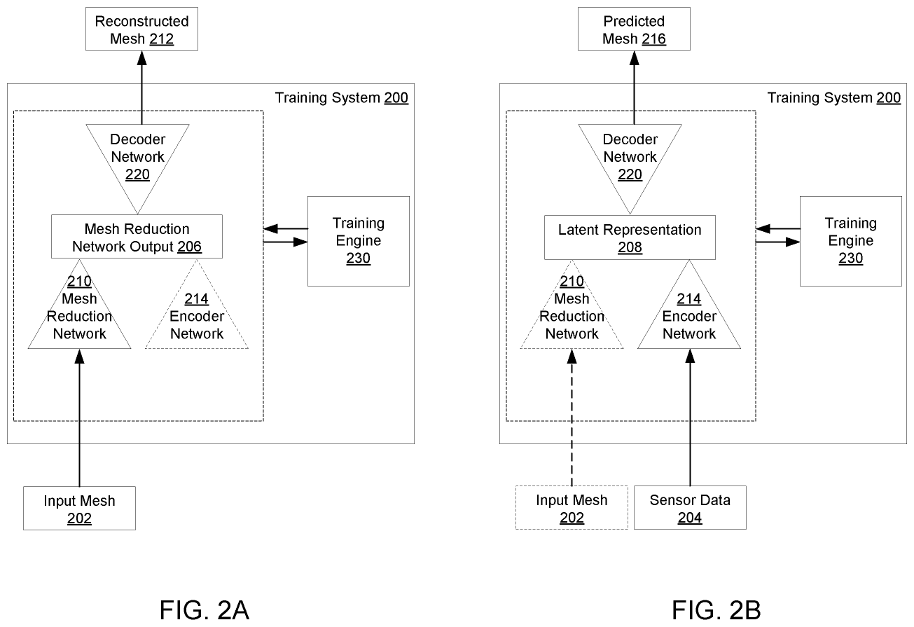

FIG. 2A is a block diagram of an example training system 200 in context of training a mesh reduction network 210 and a decoder network 220. The training system 200 is an example of a system implemented as computer programs on one or more computers in one or more locations, in which the systems, components, and techniques described below can be implemented.

The training process is typically computationally expensive. Thus, the training system 200 is commonly physically remote from facilities that house the workcell 170 or the execution system 110.

The training system 230 includes a mesh reduction network 110, an encoder network 214, and a decoder network 220. Each of networks 210, 214, and 220 is a neural network that can each include one or more neural network layers, including one or more fully connected layers, one or more convolutional layers, or one or more recurrent layers. The networks 210, 214, and 220 need not, and generally will not, have the same structure.

The training system 200 also includes a training engine 230 which trains the networks on a training dataset including a plurality of training inputs. Each training input includes (i) sensor data characterizing an object and (ii) data specifying a mesh of the object. The training inputs can generally be generated offline, i.e., independently from robots that are in operation. When generating training inputs offline, because there is enough time for any time-consuming (and, potentially accurate) mesh estimation techniques, including, for example, iterative or geometric-base fitting processes, the mesh data can be obtained with high qualities. An exemplary set of high-quality mesh representations typically have a same connectivity. The training system 200 can maintain such training inputs, for example, in a physical data storage device (not shown in the figure).

As indicated by the solid lines depicted in FIG. 2A, the training engine 230 trains the networks 210 and 212 to generate a reconstruction 212 of a received network input 202. The training engine 230 can perform the training by updating current values of respective parameters of the mesh reduction network 210 and the decoder network 220.

In some implementations, each input 202 specifies a mesh representation of an object. The exact data structures or contents of the mesh representations may vary, but typically, each mesh representation is a multi-dimensional computer graphics modeling of a physical object. For example, the input 202 can include data specifying a set of polygonal elements which collectively define a three-dimensional geometrical shape of an object. The input data also specifies respective vertices of the polygonal elements whose coordinates are defined with respect to a suitable coordinate frame.

The mesh reduction network 210 and the decoder network 220 can be collectively referred to as an auto-encoder network. In more detail, the mesh reduction network 210 can be configured to receive the input mesh 202 and process the input mesh 202 in accordance with a set of mesh reduction network parameters to generate a mesh reduction network output 206 in a latent space. In other words, the output 206 includes a set of latent variables that are generated by the mesh reduction network 210 based on processing the input mesh 202. A latent variable can have any value that is defined by the mesh reduction network output 206. Once the network 210 has been trained, the mesh reduction network output can represent features of the input mesh 220. In some implementations, the features include coordinate or texture features of the object characterized by the input mesh, including, for example, UV coordinate features of the object surface. In some implementations, the mesh reduction network output 206 is a lower-dimensional version of the input mesh 202. For example, while mesh representations are typically three-dimensional, the UV coordinates reside in a two-dimensional space.

The decoder network 220 can be configured to receive the mesh reduction network output 206 and process the output 206 in accordance with a set of decoder network parameters to generate a reconstruction 212 of the input mesh 202.

Specifically, in such implementations, the training engine 230 trains mesh reduction network 210 to generate high quality mesh reduction network outputs 206. The training engine 230 also trains the decoder network 230 to generate high quality reconstructions of the input meshes 202. The quality of the reconstructions can be determined, for example, by using an appropriate metric which measures a difference between the input mesh and the reconstructed mesh.

FIG. 2B is a block diagram of the example training system 200 in context of training an encoder network 214.

Briefly, as indicated by the solid lines depicted in FIG. 2B, the training engine 230 trains the encoder network 214 to generate a latent representation 208 of a received network input 204.

In some implementations, the input 204 includes sensor data characterizing a physical object. For example, the sensor data includes point cloud data which can be obtained by using appropriate sensors, including, for example, LIDAR sensors or depth camera sensors.

In particular, in such implementations, the encoder network 214 can be configured to receive as input sensor data 204 and process the input 204 in accordance with a set of encoder network parameters to generate a latent representation 208 based on the input 204.

As similarly described above with respect to the mesh reduction network output 206, the latent representation 206 includes a set of latent variables and can represent features of the input sensor data 204.

Specifically, in such implementations, the training engine 230 trains the encoder network 214 to generate high quality latent representations 208 that closely resemble the mesh reduction network outputs 206, i.e., in cases where inputs 202 and 204 include respective data characterizing a same object.

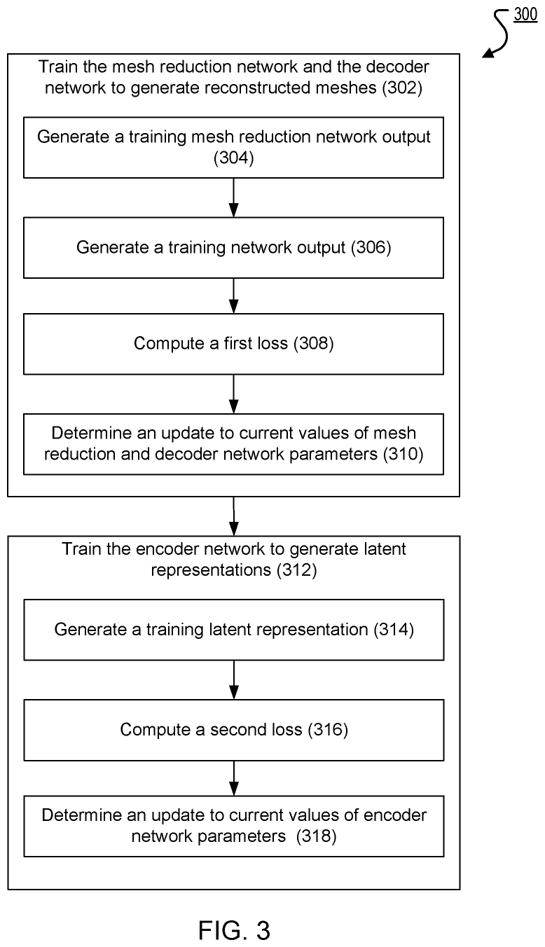

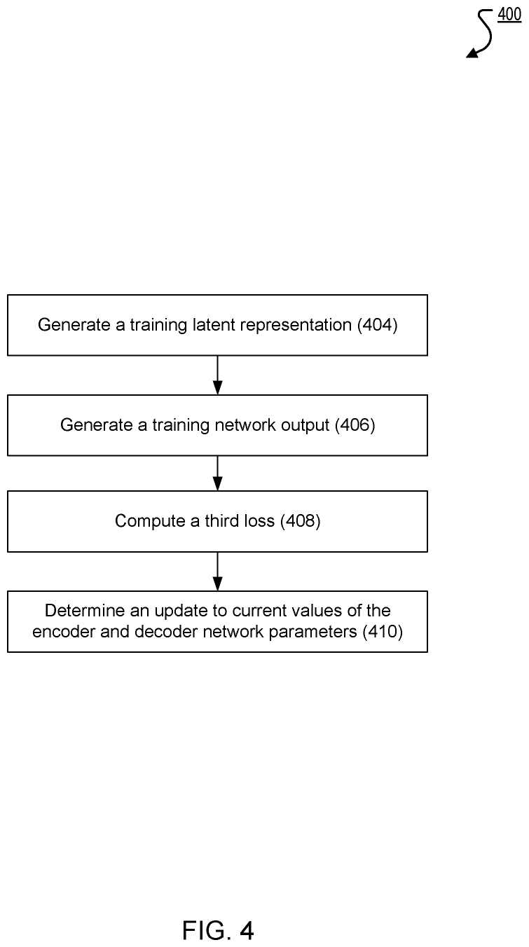

Training these networks will be described in more detail below with reference to FIGS. 3-4.

FIG. 3 is a flowchart of an example process 300 for training the networks to generate reconstructed meshes or latent representations. For convenience, the process 300 will be described as being performed by a system of one or more computers located in one or more locations. For example, a training system, e.g., the training system 200 of FIGS. 2A or 2B, appropriately programmed in accordance with this specification, can perform the process 300.

In general, the process 300 involves training the mesh reduction network and the decoder network to generate reconstructed meshes (302), and training the encoder network to generate latent representations (312). Performing step 302 in turn includes repeatedly generating a training mesh reduction network output (204), generating a training network output (306), computing a first loss (308), and determining an update to current values of mesh reduction and decoder network parameters (310). Performing step 312 in turn includes repeatedly generating a training latent representations (314), computing a second loss (316), and determining an update to current values of encoder network parameters (318).

Briefly, the system can repeatedly perform the steps 304-310 and steps 314-318 for different training inputs. Each training input includes (i) sensor data characterizing an object and (ii) data specifying a mesh of the object.

More specifically, the system generates a training mesh reduction network output (304) by processing a training input using the mesh reduction network. The mesh reduction network is configured to process, in accordance with current values of the mesh reduction network parameters, the mesh data included in the training input and to generate the training mesh reduction network output.

In general, the mesh reduction network output is a numeric representation in the latent space that has a fixed dimensionality that is lower than the dimensionality of the training input. For example, the mesh reduction network output can be a vector or a matrix of fixed size.

The system generates a training network output (306) by processing the training mesh reduction network output using the decoder network. The decoder network is configured to process, in accordance with current values of the decoder network parameters, the training mesh reduction output and to generate the training network output. In particular, the training network output specifies a reconstruction of the input mesh data.

The system computes a first loss (308) based on a measure of difference between the training network output and the training input. The first loss typically corresponds to a reconstruction loss. For example, the system can compute the first loss by the evaluating a first objective function which measures a difference between the input mesh and the reconstructed mesh. The input mesh and the reconstructed mesh are characterized by the training input and the training network output, respectively.

The system determines an update to the current values of the mesh reduction network parameters and the decoder network parameters (310). The system can do so by computing a gradient of the first loss with respect to respective parameters of the mesh reduction network and the decoder network.

The system then proceeds to update the current values of the network parameters using an appropriate machine learning optimization technique (e.g., stochastic gradient descent, Adam, or RMSProp). Alternatively, the system only proceeds to update the current parameter values once the steps 304-310 have been performed for an entire mini-batch of training inputs. A mini-batch generally includes a fixed number of training inputs, e.g., 16, 64, or 256. In other words, the system combines respective updates that are determined during the fixed number of iterations of steps 304-310 and proceeds to update the current parameter values based on the combined update.

After a specified number of training iterations have been performed or after the gradient of the first objective function has converged to a specified value, the system determines that the training of the mesh reduction network and the decoder network can be terminated.

Typically, upon termination of the training step 302, the system has become capable of generating high-quality reconstructed meshes that closely resemble the input meshes. Such high-quality reconstruction in turn relies on the fact that the mesh reduction network has become able to generate high-quality mesh reduction network outputs which accurately capture latent features of the input meshes. These feature can include, for example, geometric features of the set of polygonal elements that are specified by the input meshes.

The system then proceeds to train the encoder network to generate latent representations (312).

The system generates a training latent representation (314) by processing the training input using the encoder network. The encoder network is configured to process, in accordance with current values of the encoder network parameters, the sensor data included in the training input and to generate the training latent representation.

In general, the latent representation is a numeric representation in the latent space that has a fixed dimensionality that is lower than the dimensionality of the training input. For example, the latent representation can be a vector or a matrix of fixed size.

The system computes a second loss (316) based on a measure of difference between the training latent representation and a corresponding mesh reduction network output. For example, the system can compute the second loss by evaluating a second objective function which measures a difference between (i) the training latent representation and (ii) the corresponding mesh reduction network output.

In particular, the system can obtain the corresponding mesh reduction network output by processing the input mesh that included in the same training input using the (trained) mesh reduction network. For example, the system can use the mesh reduction network to process, in accordance with trained values of the mesh reduction network parameters, the mesh data included in the same training input to generate the mesh reduction network output for use in loss computation.

As another example, the system can obtain the corresponding mesh reduction network output from the training log of the previous training step 302. In other words, the system can store the training mesh reduction network outputs that were generated during (at least some of the iterations of) the training of the mesh reduction network and retrieve these stored training mesh reduction network outputs as the corresponding mesh reduction network outputs for use in training the encoder network.

The system determines an update to current values of the encoder network parameters (318). The system can do so by computing a gradient of the second loss with respect to the encoder network parameters.

The system then proceeds to update the current values of the encoder network parameters using an appropriate machine learning optimization technique (e.g., stochastic gradient descent, Adam, or RMSProp). Alternatively, the system only proceeds to update the current encoder parameter values once the steps 314-318 have been performed for an entire mini-batch of training inputs. A mini-batch generally includes a fixed number of training inputs, e.g., 16, 64, or 256. In other words, the system combines respective updates that are determined during the fixed number of iterations of steps 314-318 and proceeds to update the current parameter values based on the combined update.

Instead of or in addition to training the encoder network to latent representations of the training inputs, the system can also jointly train the encoder and decoder networks to generate predicted meshes. That is, in some implementations, the system performs process 300 as an alternative or a subsequent step to step 312. In particular, in such implementations, the system generally keeps the trained values of the decoder network parameters fixed (at least relatively) and specifically adjusts the values of the encoder network parameters. Training the encoder and decoder networks to generate predicted meshes will be described in more detail below.

FIG. 4 is a flowchart of an example process 400 for training the encoder and decoder networks to generate predicted meshes. For convenience, the process 400 will be described as being performed by a system of one or more computers located in one or more locations. For example, a training system, e.g., the training system 100 of FIG. 1, appropriately programmed in accordance with this specification, can perform the process 400.As similarly described above with reference to FIG. 3, the system can repeatedly perform the process 400 for different training inputs.

The system generates a training latent representation (404) by processing the training input using the encoder network. The encoder network is configured to process, in accordance with current values of the encoder network parameters, the sensor data included in the training input and to generate the training latent representation.

While being generated from different types of input data, the latent representation and the mesh reduction network output (that would have been generated by the mesh reduction network based on processing the input mesh included in the training input) should have a same dimensionality.

The system generates a training network output (406) by processing the training latent representation using the decoder network. The decoder network is configured to process, in accordance with current values of the decoder network parameters, the training latent representation and to generate the training network output. In particular, the training network output specifies a predicted mesh of the object that is in turn characterized by the input sensor data.

The system computes a third loss (408) based on a measure of difference between the training network output and the training input. For example, the system can compute the third loss by the evaluating a third objective function which measures a difference between the predicted mesh and the input mesh that is included in the training input.

The system determines an update to the current values of encoder network parameters and the decoder network parameters (410). The system can do so by computing a gradient of the third loss with respect to respective parameters of the encoder and the decoder networks.

The system then proceeds to update the current values of the network parameters using an appropriate machine learning optimization technique (e.g., stochastic gradient descent, Adam, or RMSProp). Alternatively, the system only proceeds to update the current parameter values once the steps 404-410 have been performed for an entire mini-batch of training inputs. A mini-batch generally includes a fixed number of training inputs, e.g., 16, 64, or 256. In other words, the system combines respective updates that are determined during the fixed number of iterations of steps 404-410 and proceeds to update the current parameter values based on the combined update.

After the training is complete, the training system 200 can provide a set of trained parameter values of the networks to the robotics system 100 of FIG. 1, e.g., by a wired or wireless connection. Specifically, the training system 200 can provide the trained parameter values of the encoder network and the decoder network to the encoder-decoder engine 120 included in the execution system 110 for use in generating estimated meshes based on received observations which further enable the motion planner 150 to issue timely commands which adjust the currently planned trajectories of the robots.

By incorporating the lower-dimensional coordinate or texture feature information of the objects that has been extracted by the encoder-decoder engine into the trajectory planning process, the execution system can determine adjusted trajectories in a way that is efficient, accurate, or both. In particular, to determine the adjusted trajectory, the execution system can first parameterize the trajectory relative to the deformable object in the lower-dimensional coordinate space, and then effectively adapt the currently planned trajectory to a deformable object by computing a 1-D offset to account for any surface deformation (according to the estimated mesh). This saves the extra amount of time, computational resources, or both that is otherwise required for re-generating a completely new trajectory with reference to a much higher-dimensional space.

In this specification, a robot is a machine having a base position, one or more movable components, and a kinematic model that can be used to map desired positions, poses, or both in one coordinate system, e.g., Cartesian coordinates, into commands for physically moving the one or more movable components to the desired positions or poses. In this specification, a tool is a device that is part of and is attached at the end of the kinematic chain of the one or more moveable components of the robot. Example tools include grippers, welding devices, and sanding devices.

In this specification, a task is an operation to be performed by a tool. For brevity, when a robot has only one tool, a task can be described as an operation to be performed by the robot as a whole. Example tasks include welding, glue dispensing, part positioning, and surfacing sanding, to name just a few examples. Tasks are generally associated with a type that indicates the tool required to perform the task, as well as a position within a workcell at which the task will be performed.

In this specification, a motion plan is a data structure that provides information for executing an action, which can be a task, a cluster of tasks, or a transition. Motion plans can be fully constrained, meaning that all values for all controllable degrees of freedom for the robot are represented explicitly or implicitly; or underconstrained, meaning that some values for controllable degrees of freedom are unspecified. In some implementations, in order to actually perform an action corresponding to a motion plan, the motion plan must be fully constrained to include all necessary values for all controllable degrees of freedom for the robot. Thus, at some points in the planning processes described in this specification, some motion plans may be underconstrained, but by the time the motion plan is actually executed on a robot, the motion plan can be fully constrained. In some implementations, motion plans represent edges in a task graph between two configuration states for a single robot. Thus, generally there is one task graph per robot.

In this specification, a motion swept volume is a region of the space that is occupied by a least a portion of a robot or tool during the entire execution of a motion plan. The motion swept volume can be generated by collision geometry associated with the robot-tool system.

In this specification, a planned trajectory is a motion plan that describes a movement to be performed between a start point and an end point. The start point and end point can be represented by poses, locations in a coordinate system, or tasks to be performed. Motion plans can be underconstrained by lacking one or more values of one or more respective controllable degrees of freedom (DOF) for a robot. Some motion plans represent free motions. In this specification, a free motion is a transition in which none of the degrees of freedom are constrained. For example, a robot motion that simply moves from pose A to pose B without any restriction on how to move between these two poses is a free motion. During the planning process, the DOF variables for a free motion are eventually assigned values, and motion planners can use any appropriate values for the motion that do not conflict with the physical constraints of the workcell.

The robot functionalities described in this specification can be implemented by a hardware-agnostic software stack, or, for brevity just a software stack, that is at least partially hardware-agnostic. In other words, the software stack can accept as input commands generated by the planning processes described above without requiring the commands to relate specifically to a particular model of robot or to a particular robotic component. For example, the software stack can be implemented at least partially by the onsite execution engine 150 and the robot interface subsystem 160 of FIG. 1.

The software stack can include multiple levels of increasing hardware specificity in one direction and increasing software abstraction in the other direction. At the lowest level of the software stack are robot components that include devices that carry out low-level actions and sensors that report low-level statuses. For example, robots can include a variety of low-level components including motors, encoders, cameras, drivers, grippers, application-specific sensors, linear or rotary position sensors, and other peripheral devices. As one example, a motor can receive a command indicating an amount of torque that should be applied. In response to receiving the command, the motor can report a current position of a joint of the robot, e.g., using an encoder, to a higher level of the software stack.

Each next highest level in the software stack can implement an interface that supports multiple different underlying implementations. In general, each interface between levels provides status messages from the lower level to the upper level and provides commands from the upper level to the lower level.

Typically, the commands and status messages are generated cyclically during each control cycle, e.g., one status message and one command per control cycle. Lower levels of the software stack generally have tighter real-time requirements than higher levels of the software stack. At the lowest levels of the software stack, for example, the control cycle can have actual real-time requirements. In this specification, real-time means that a command received at one level of the software stack must be executed and optionally, that a status message be provided back to an upper level of the software stack, within a particular control cycle time. If this real-time requirement is not met, the robot can be configured to enter a fault state, e.g., by freezing all operation.

At a next-highest level, the software stack can include software abstractions of particular components, which will be referred to motor feedback controllers. A motor feedback controller can be a software abstraction of any appropriate lower-level components and not just a literal motor. A motor feedback controller thus receives state through an interface into a lower-level hardware component and sends commands back down through the interface to the lower-level hardware component based on upper-level commands received from higher levels in the stack. A motor feedback controller can have any appropriate control rules that determine how the upper-level commands should be interpreted and transformed into lower-level commands. For example, a motor feedback controller can use anything from simple logical rules to more advanced machine learning techniques to transform upper-level commands into lower-level commands. Similarly, a motor feedback controller can use any appropriate fault rules to determine when a fault state has been reached. For example, if the motor feedback controller receives an upper-level command but does not receive a lower-level status within a particular portion of the control cycle, the motor feedback controller can cause the robot to enter a fault state that ceases all operations.

At a next-highest level, the software stack can include actuator feedback controllers. An actuator feedback controller can include control logic for controlling multiple robot components through their respective motor feedback controllers. For example, some robot components, e.g., a joint arm, can actually be controlled by multiple motors. Thus, the actuator feedback controller can provide a software abstraction of the joint arm by using its control logic to send commands to the motor feedback controllers of the multiple motors.

At a next-highest level, the software stack can include joint feedback controllers. A joint feedback controller can represent a joint that maps to a logical degree of freedom in a robot. Thus, for example, while a wrist of a robot might be controlled by a complicated network of actuators, a joint feedback controller can abstract away that complexity and exposes that degree of freedom as a single joint. Thus, each joint feedback controller can control an arbitrarily complex network of actuator feedback controllers. As an example, a six degree-of-freedom robot can be controlled by six different joint feedback controllers that each control a separate network of actual feedback controllers.

Each level of the software stack can also perform enforcement of level-specific constraints. For example, if a particular torque value received by an actuator feedback controller is outside of an acceptable range, the actuator feedback controller can either modify it to be within range or enter a fault state.

To drive the input to the joint feedback controllers, the software stack can use a command vector that includes command parameters for each component in the lower levels, e.g., a positive, torque, and velocity, for each motor in the system. To expose status from the joint feedback controllers, the software stack can use a status vector that includes status information for each component in the lower levels, e.g., a position, velocity, and torque for each motor in the system. In some implementations, the command vectors also include some limit information regarding constraints to be enforced by the controllers in the lower levels.

At a next-highest level, the software stack can include joint collection controllers. A joint collection controller can handle issuing of command and status vectors that are exposed as a set of part abstractions. Each part can include a kinematic model, e.g., for performing inverse kinematic calculations, limit information, as well as a joint status vector and a joint command vector. For example, a single joint collection controller can be used to apply different sets of policies to different subsystems in the lower levels. The joint collection controller can effectively decouple the relationship between how the motors are physically represented and how control policies are associated with those parts. Thus, for example if a robot arm has a movable base, a joint collection controller can be used to enforce a set of limit policies on how the arm moves and to enforce a different set of limit policies on how the movable base can move.

At a next-highest level, the software stack can include joint selection controllers. A joint selection controller can be responsible for dynamically selecting between commands being issued from different sources. In other words, a joint selection controller can receive multiple commands during a control cycle and select one of the multiple commands to be executed during the control cycle. The ability to dynamically select from multiple commands during a real-time control cycle allows greatly increased flexibility in control over conventional robot control systems.

At a next-highest level, the software stack can include joint position controllers. A joint position controller can receive goal parameters and dynamically compute commands required to achieve the goal parameters. For example, a joint position controller can receive a position goal and can compute a set point for achieve the goal.

At a next-highest level, the software stack can include Cartesian position controllers and Cartesian selection controllers. A Cartesian position controller can receive as input goals in Cartesian space and use inverse kinematics solvers to compute an output in joint position space. The Cartesian selection controller can then enforce limit policies on the results computed by the Cartesian position controllers before passing the computed results in joint position space to a joint position controller in the next lowest level of the stack. For example, a Cartesian position controller can be given three separate goal states in Cartesian coordinates x, y, and z. For some degrees, the goal state could be a position, while for other degrees, the goal state could be a desired velocity.

These functionalities afforded by the software stack thus provide wide flexibility for control directives to be easily expressed as goal states in a way that meshes naturally with the higher-level planning techniques described above. In other words, when the planning process uses a process definition graph to generate concrete actions to be taken, the actions need not be specified in low-level commands for individual robotic components. Rather, they can be expressed as high-level goals that are accepted by the software stack that get translated through the various levels until finally becoming low-level commands. Moreover, the actions generated through the planning process can be specified in Cartesian space in way that makes them understandable for human operators, which makes debugging and analyzing the schedules easier, faster, and more intuitive. In addition, the actions generated through the planning process need not be tightly coupled to any particular robot model or low-level command format. Instead, the same actions generated during the planning process can actually be executed by different robot models so long as they support the same degrees of freedom and the appropriate control levels have been implemented in the software stack.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g., a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network.

The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments described above, the following embodiments are also innovative:

Embodiment 1 is a method comprising:

obtaining, by a robotic system including one or more robots that operate on a deformable object, a neural network configured to receive a network input that includes sensor data characterizing the deformable object and to process the network input to generate a network output that specifies a mesh of the deformable object;

receiving sensor data for the deformable object;

processing the sensor data using the neural network to generate a mesh representing the deformable object;

generating, from a currently planned motion, an adjusted motion according to the mesh representing the deformable object; and

executing, by the robotic system, the adjusted motion using the one or more robots.

Embodiment 2 is the method of embodiment 1, wherein generating the adjusted motion according to the mesh comprises parameterizing the currently planned motion relative to the deformable object.

Embodiment 3 is the method of any one of embodiments 1-2, wherein generating the adjusted motion according to the mesh further comprises determining a one-dimensional offset between the currently planned motion and object surface.

Embodiment 4 is the method of any one of embodiments 1-3, wherein the sensor data comprises point cloud data.

Embodiment 5 is a method comprising:

training a neural network configured to receive a network input that includes sensor data characterizing a deformable object and to process the network input to generate a network output that specifies a mesh of the deformable object, wherein the neural network includes (i) an encoder network having a plurality of encoder network parameters and configured to process the network input in accordance with current values of the encoder network parameters to generate a latent representation based on the network input and (ii) a decoder network having a plurality of decoder network parameters and configured to process the latent representation in accordance with current values of the decoder network parameters to generate the network output, the method comprising:
training a mesh reduction network and the decoder network on a plurality of training inputs, wherein each training input comprises (i) sensor data characterizing an object and (ii) data specifying a mesh of the object, wherein the mesh reduction network has a plurality of mesh reduction network parameters and is configured to process a training input in accordance with current values of the mesh reduction network parameters to generate a mesh reduction network output, and wherein the training comprises, for each training input:
   processing the training input using the mesh reduction network to generate a training mesh reduction network output based on the training input;
   processing the training mesh reduction network output using the decoder network to generate a training network output;
   computing a first loss based on a measure of difference between the training network output and the training input; and
   determining, based on computing a gradient of the first loss with respect to respective parameters of the mesh reduction network and the decoder network, an update to the current values of the mesh reduction network parameters and the decoder network parameters; and
after the training, training the encoder network to generate the latent representations, comprising, for each training input:
   processing the training input using the encoder network to generate a training latent representation;
   computing a second loss based on a measure of difference between the training latent representation and a corresponding mesh reduction network output; and
   determining, based on computing a gradient of the second loss with respect to the encoder network parameters, an update to current values of the encoder network parameters.

Embodiment 6 is the method of embodiment 5, wherein training the encoder network to generate the latent representations further comprises, for each training input:
processing the training input using the encoder network to generate a training latent representation;
processing the training latent representation using the decoder network to generate a training network output;
computing a third loss based on a measure of difference between the training network output and the training input; and
determining, based on computing a gradient of the third loss with respect to respective parameters of the encoder network and the decoder network, an update to the current values of encoder network parameters and the decoder network parameters.

Embodiment 7 is the method of any one of embodiments 5-6, further comprising providing the trained parameter values of the encoder and decoder networks for use in deploying, in a robotic system including one or more robots that operate on a deformable object, a neural network that is configured to receive as input sensor data characterizing the deformable object and to process the input to generate an output that specifies a mesh of the deformable object.

Embodiment 8 is the method of any one of embodiments 5-7, wherein for each training input, the mesh is generated from the sensor data and by using an iterative fitting technique.

Embodiment 9 is the method of embodiment 8, wherein the generated meshes have a same connectivity.

Embodiment 10 is a system comprising: one or more computers and one or more storage devices storing instructions that are operable, when executed by the one or more computers, to cause the one or more computers to perform the method of any one of embodiments 1 to 9.

Embodiment 11 is a computer storage medium encoded with a computer program, the program comprising instructions that are operable, when executed by data processing apparatus, to cause the data processing apparatus to perform the method of any one of embodiments 1 to 9.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain some cases, multitasking and parallel processing may be advantageous.

What is claimed is:

1. A method performed by one or more computers, the method comprising:
obtaining, by a robotic system including one or more robots that operate on a deformable object, a neural network configured to receive a network input that includes sensor data characterizing the deformable object and to process the network input to generate a network output that specifies a mesh of the deformable object;
receiving sensor data for the deformable object;
processing the sensor data using the neural network to generate a mesh representing the deformable object;
generating, from a currently planned motion, an adjusted motion according to the mesh representing the deformable object; and
executing, by the robotic system, the adjusted motion using the one or more robots.

2. The method of claim 1, wherein generating the adjusted motion according to the mesh comprises parameterizing the currently planned motion relative to the deformable object.

3. The method of claim 1, wherein generating the adjusted motion according to the mesh further comprises determining a one-dimensional offset between the currently planned motion and object surface.

4. The method of claim 1, wherein the sensor data comprises point cloud data.

5. A method of training a neural network configured to receive a network input that includes sensor data characterizing a deformable object and to process the network input to generate a network output that specifies a mesh of the deformable object, wherein the neural network includes (i) an encoder network having a plurality of encoder network parameters and configured to process the network input in accordance with current values of the encoder network parameters to generate a latent representation based on the network input and (ii) a decoder network having a plurality of decoder network parameters and configured to process the latent representation in accordance with current values of the decoder network parameters to generate the network output, the method comprising:
training a mesh reduction network and the decoder network on a plurality of training inputs, wherein each training input comprises (i) sensor data characterizing an object and (ii) data specifying a mesh of the object, wherein the mesh reduction network has a plurality of mesh reduction network parameters and is configured to process a training input in accordance with current values of the mesh reduction network parameters to generate a mesh reduction network output, and wherein the training comprises, for each training input:
processing the training input using the mesh reduction network to generate a training mesh reduction network output based on the training input;
processing the training mesh reduction network output using the decoder network to generate a training network output;
computing a first loss based on a measure of difference between the training network output and the training input; and
determining, based on computing a gradient of the first loss with respect to respective parameters of the mesh reduction network and the decoder network, an update to the current values of the mesh reduction network parameters and the decoder network parameters; and
after the training, training the encoder network to generate the latent representations, comprising, for each training input:
processing the training input using the encoder network to generate a training latent representation;
computing a second loss based on a measure of difference between the training latent representation and a corresponding mesh reduction network output; and
determining, based on computing a gradient of the second loss with respect to the encoder network parameters, an update to current values of the encoder network parameters.

6. The method of claim 5, wherein training the encoder network to generate the latent representations further comprises, for each training input:
processing the training input using the encoder network to generate a training latent representation;
processing the training latent representation using the decoder network to generate a training network output;
computing a third loss based on a measure of difference between the training network output and the training input; and
determining, based on computing a gradient of the third loss with respect to respective parameters of the encoder network and the decoder network, an update to the current values of encoder network parameters and the decoder network parameters.

7. The method of claim 6, further comprising:
providing the trained parameter values of the encoder and decoder networks for use in deploying, in a robotic system including one or more robots that operate on a deformable object, a neural network that is configured to receive as input sensor data characterizing the deformable object and to process the input to generate an output that specifies a mesh of the deformable object.

8. The method of claim 5, wherein for each training input, the mesh is generated from the sensor data and by using an iterative fitting technique.

9. The method of claim 8, wherein the generated meshes have a same connectivity.

10. A system comprising:
one or more computers; and
one or more storage devices storing instructions that, when executed by the one or more computers, cause the one or more computers to perform operations comprising:
obtaining, by a robotic system including one or more robots that operate on a deformable object, a neural network configured to receive a network input that includes sensor data characterizing the deformable object and to process the network input to generate a network output that specifies a mesh of the deformable object;
receiving sensor data for the deformable object;
processing the sensor data using the neural network to generate a mesh representing the deformable object;
generating, from a currently planned motion, an adjusted motion according to the mesh representing the deformable object; and
executing, by the robotic system, the adjusted motion using the one or more robots.

11. The system of claim 10, wherein generating the adjusted motion according to the mesh comprises parameterizing the currently planned motion relative to the deformable object.

12. The system of claim 10, wherein generating the adjusted motion according to the mesh further comprises determining a one-dimensional offset between the currently planned motion and object surface.

13. The system of claim 10, wherein the sensor data comprises point cloud data.

14. The system of claim 10, wherein the operations further comprise training the neural network, the neural network including (i) an encoder network having a plurality of encoder network parameters and configured to process the network input in accordance with current values of the encoder network parameters to generate a latent representation based on the network input and (ii) a decoder network having a plurality of decoder network parameters and configured to process the latent representation in accordance with current values of the decoder network parameters to generate the network output, wherein the training comprises:
training a mesh reduction network and the decoder network on a plurality of training inputs, wherein each training input comprises (i) sensor data characterizing an object and (ii) data specifying a mesh of the object, wherein the mesh reduction network has a plurality of mesh reduction network parameters and is configured to process a training input in accordance with current values of the mesh reduction network parameters to generate a mesh reduction network output, and wherein the training comprises, for each training input:
processing the training input using the mesh reduction network to generate a training mesh reduction network output based on the training input;
processing the training mesh reduction network output using the decoder network to generate a training network output;
computing a first loss based on a measure of difference between the training network output and the training input; and
determining, based on computing a gradient of the first loss with respect to respective parameters of the mesh reduction network and the decoder network, an update to the current values of the mesh reduction network parameters and the decoder network parameters; and
after training the mesh reduction network and the decoder network, training the encoder network to generate the latent representations, comprising, for each training input:
processing the training input using the encoder network to generate a training latent representation;
computing a second loss based on a measure of difference between the training latent representation and a corresponding mesh reduction network output; and
determining, based on computing a gradient of the second loss with respect to the encoder network parameters, an update to current values of the encoder network parameters.

15. The system of claim 14, wherein training the encoder network to generate the latent representations further comprises, for each training input:
processing the training input using the encoder network to generate a training latent representation;
processing the training latent representation using the decoder network to generate a training network output;
computing a third loss based on a measure of difference between the training network output and the training input; and
determining, based on computing a gradient of the third loss with respect to respective parameters of the encoder network and the decoder network, an update to the current values of encoder network parameters and the decoder network parameters.

16. The system of claim 15, wherein the operations further comprise:
providing the trained parameter values of the encoder and decoder networks for use in deploying, in a robotic system including one or more robots that operate on a deformable object, a neural network that is configured to receive as input sensor data characterizing the deformable object and to process the input to generate an output that specifies a mesh of the deformable object.

17. The system of claim 16, wherein for each training input, the mesh is generated from the sensor data and by using an iterative fitting technique.

18. The system of claim 14, wherein the generated meshes have a same connectivity.
